(19) United States
(12) Patent Application Publication
(10) Pub. No.: US 2024/0128903 A1
(43) Pub. Date: Apr. 18, 2024

(54) METHOD OF CONTROLLING A THREE-PHASE PERMANENT-MAGNET MOTOR

(71) Applicant: Dyson Technology Limited, Wiltshire (GB)

(72) Inventor: Máté HORVÁT, Swindon (GB)

(73) Assignee: Dyson Technology Limited, Wiltshire (GB)

(21) Appl. No.: 18/278,389

(22) PCT Filed: Feb. 16, 2022
(86) PCT No.: PCT/GB2022/050417

§ 371 Date: Aug. 22, 2023

(30) Foreign Application Priority Data
Feb. 25, 2021 (GB) 2102703.2

(51) Int. Cl. H02P 6/185; H02P 6/17

(52) U.S. Cl. CPC H02P 6/185; H02P 6/17

(57) ABSTRACT

A method is described for controlling a three-phase permanent-magnet motor. The method includes sequentially exciting and freewheeling phases of the motor. The phases are freewheeled when a magnitude of phase current rises to an upper threshold, and freewheeling continues for either a fixed period of time or until the magnitude of the phase current decreases to a lower threshold. The method further includes measuring a parameter that corresponds to either the magnitude of the phase current during or at the end of freewheeling, or an interval between a start and end of freewheeling or a start and end of excitation. A saturation event is determined to have occurred when the measured parameter is less than a saturation threshold. In response to the saturation event, the phases are commutated.

### FIELD OF THE INVENTION

The present invention relates to a method of controlling a three-phase permanent magnet motor.

### BACKGROUND OF THE INVENTION

In a brushless permanent-magnet motor, knowledge of the rotor position is often necessary in order to ensure that the phases are commutated at the appropriate times. The motor may include one or more sensors for determining the position of the rotor, such as Hall-effect sensors or an optical encoder. Whilst the component cost of the sensors may be relatively inexpensive, integrating the sensors within the motor may be challenging, particularly in a compact arrangement. Sensorless schemes for determining the position of the rotor are known. Such schemes typically determine the position of the rotor based on the back EMF induced in the phases by the rotor. However, since the magnitude of the back EMF is proportional to the speed of the rotor, the position of the rotor cannot always be reliably determined at low speeds.

### SUMMARY OF THE INVENTION

The present invention provides a method of controlling a three-phase permanent-magnet motor, the method comprising: sequentially exciting and freewheeling phases of the motor over a plurality of sectors, wherein the phases are excited with a different voltage vector for each sector, the phases are freewheeled when a magnitude of phase current increases to an upper threshold, and the phase are freewheeled for a fixed period of time or until the magnitude of the phase current decreases to a lower threshold; measuring a parameter corresponding to a magnitude of the phase current during or at the end of freewheeling when the phases are freewheeled for the fixed period of time, or an interval between a start and end of freewheeling or a start and end of excitation when the phases are freewheeled until the magnitude of the phase current decreases to the lower threshold; determining that a saturation event has occurred when the measured parameter is less than a saturation threshold; and commutating the phases in response to the saturation event, wherein the method comprises either (i) using a first saturation threshold when determining a saturation event within a first sector, and using a second different saturation threshold when determining a saturation event within a second sector, or (ii) commutating the phases multiple times in response to the saturation event.

With the method of the present invention, changes in the inductance of the phases, rather than back EMF, are used to determine the rotor position. As the rotor rotates, the total magnetic flux linked by the stator varies. As the rotor approaches a commutation position (i.e. the position at which the phases are ideally commutated), the total magnetic flux linked by the stator increases and the stator begins to saturate. As the stator begins to saturate, the inductance of the phases decreases. As a result, the rates at which the phase current rises during excitation and falls during freewheeling increase. By freewheeling the phases for a fixed period of time, the magnitude of the phase current at the end of the freewheeling will decrease as the rotor approaches the commutation position. Alternatively, by chopping the phase current between an upper threshold and a lower threshold, the time taken for the magnitude of the phase current to increase to the upper threshold during excitation will decrease, as will the time taken for the magnitude of the phase current to decrease to the lower threshold during freewheeling. By measuring one of these parameters and comparing it against a saturation threshold, the position of the rotor and thus the commutation point may be determined.

The phases of the motor are sequentially excited and freewheeled over a plurality of sectors. The phases are then excited with a different voltage vector for each sector. The profile of the phase inductance (i.e. how the phase inductance varies with rotor position) may differ for different sectors. As a result, the magnitude of the phase current may rise and fall at different rates within different sectors. If a saturation event were determined for each sector using the same saturation threshold, the commutation timings would be wrong for at least one of the sectors. This would then adversely affect the torque and thus the overall efficiency of the motor.

The method may therefore use different saturation thresholds for different sectors. For example, the profile of the phase inductance over a first sector may be different to that over a second sector. The method may then use a first saturation threshold for the first sector, and a second different saturation threshold for the second sector. Alternatively, the method may commutate the phases multiple times in response to a single saturation event. For example, rather than determining saturation events for each of the first sector and the second sector, and then commutating the phases in response to each saturation event, the method may instead determine a saturation event for, say, the first sector only and then commutate the phases for the first sector and the second sector in response to the saturation event. In both situations, more accurate timing of commutation may be achieved for both sectors, in spite of the differences in phase inductance, leading to higher torque and efficiency.

The inductance of the phases may be lower for even-numbered sectors. As a result, the rate at which the phase current rises during excitation and falls during freewheeling, is higher for even-numbered sectors. Accordingly, the saturation threshold used when determining a saturation event within each even-numbered sector may be less than the saturation threshold used when determining a saturation event within each odd-numbered sector. As a result, more accurate timing of commutation may be achieved.

The profile of the phase inductance over each odd-numbered sector may be substantially the same. Likewise, the profile of the phase inductance over each even-numbered sector may be substantially the same. Accordingly, the method may use a first saturation threshold when determining a saturation event within each odd-numbered sector, and use a second saturation threshold when determining a saturation event within each even-numbered sector. As a result, more accurate timing of commutation may be achieved in a relatively simple manner, since only two saturation thresholds need be used.

The method may comprise determining an interval between the saturation event and a previous saturation event, and commutating the phases in response to the saturation event at times T and T+INT*S, where INT is the interval and S is a scaling factor. When the speed of the rotor is relatively constant, the time taken for the rotor to move from one commutation position to the next is unlikely to change significantly. Accordingly, when the speed of the rotor is relatively constant, a scaling factor of 0.5 may be employed. On the other hand, when the speed of the rotor is accelerating, the time taken for the rotor to move from one commutation position to the next commutation decreases. Accordingly, when the speed of the rotor is accelerating, a scaling factor less than 0.5 may be employed. Conversely, when the rotor is decelerating, a scaling factor greater than 0.5 may be employed. The particular value for the scaling factor may depend on the rate of acceleration or deceleration of the rotor. In particular, a lower scaling factor may be employed for a faster rate of acceleration, and a higher scaling factor may be employed for a faster rate of deceleration.

The method may be used during acceleration only of the motor. In this instance, the method may employ a scaling factor less than 0.5. This then has the advantage that the method may be used to accelerate the rotor more quickly and efficiently. In particular, by employing a scaling factor less than 0.5 during acceleration, commutation timings are likely to be more accurate and thus a higher torque is likely to be generated.

The scaling factor may be fixed over a range of motor speeds spanning at least 10 krpm. This then provides a relatively simple yet effective and efficient method of controlling the motor during acceleration and/or deceleration over a relatively large speed range.

As the rotor of the motor rotates, the rotor induces a back EMF in the phases. The back EMF acts in opposition to the applied voltage used to excite the phases. Consequently, the rate at which the magnitude of the phase current rises during excitation and falls during freewheeling depends not only on the inductance of the phases but also on the magnitude of the back EMF. As the speed of the rotor changes, so too does the magnitude of the back EMF. Consequently, if the same saturation threshold were used at different motor speeds, commutation may occur at slightly different rotor positions. This may then adversely affect the torque and efficiency of the motor. Accordingly, the method may comprise varying the saturation threshold(s) in response to a change in a speed of the motor.

As the speed of the rotor increases, so too does the magnitude of the back EMF. As a result, the rate at which the magnitude of the phase current rises during excitation decreases, and the rate at which the phase current falls during freewheeling increases. Accordingly, where the measured parameter is the magnitude of the phase current during or at the end of freewheeling, or the time interval between the start and end of freewheeling, the method may comprise decreasing the saturation threshold in response to an increase in the speed of the motor. On the other hand, where the measured parameter is the interval between the start and end of excitation, the method may comprise increasing the saturation threshold in response to an increase in the speed of the motor.

The present invention provides a three-phase permanent-magnet motor comprising a control system configured to perform a method as described in any one of the preceding paragraphs.

The control system may comprises an inverter, at least one current sensor, a gate driver module, and a controller. The inverter is then coupled to each of the phases, the current sensor outputs a signal indicative of the phase current, and the gate driver module drives the opening and closing of switches of the inverter in response to control signals from the controller. The controller (i) generates control signals to excite the phases, (ii) monitors the signal of the current sensor, (iii) generates control signals to freewheel the phases when the phase current increases to the upper threshold, (iv) measures the parameter, and (v) determines that a saturation event has occurred when the measured parameter is less than the saturation threshold.

The phases may be delta-connected. As a result, the profile of the phase inductance may be different for different sectors. In spite of this, the control system is able to achieve relatively good timing of commutation for the different sectors.

### BRIEF DESCRIPTION OF THE DRAWINGS

Embodiments will now be described, by way of example, with reference to the accompanying drawings in which:

FIG. 1 is a sectional view through a brushless motor;

FIG. 2 is a schematic diagram of the brushless motor;

FIG. 3 is a table detailing the voltage vectors for six-step control, along with the states of the switches of the inverter of the brushless motor when the phases of the motor are star-connected (top) and delta-connected (bottom);

FIG. 4 is a flow diagram of a method for performing sensorless six-step control;

FIG. 5 illustrates the profile of the phase current over one electrical cycle for a motor having star-connected phases;

FIG. 6 illustrates the profile of the phase current over one electrical cycle for a motor having delta-connected phases; and

FIG. 7 illustrates the profile of the phase current for a motor having delta-connected phases that is accelerating.

### DETAILED DESCRIPTION OF THE INVENTION

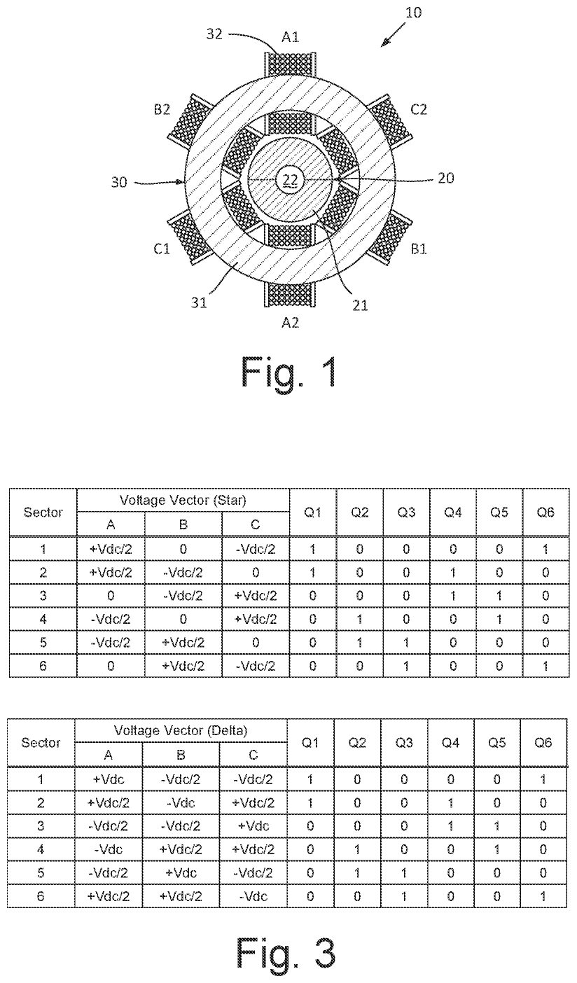

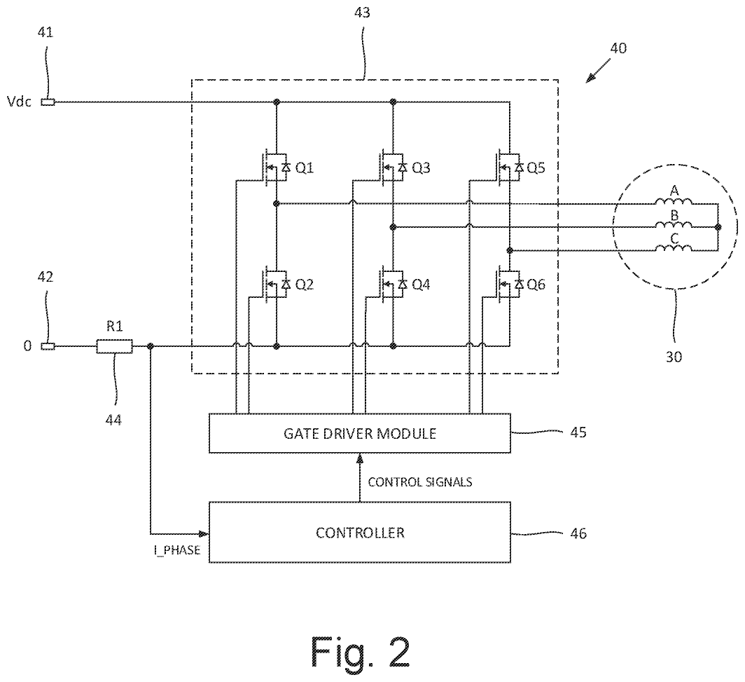

The brushless motor 10 of FIGS. 1 and 2 comprises a rotor 20, a stator 30, and a control system 40.

The rotor 20 comprises a permanent magnet 21 secured to a shaft 22. In the particular example shown in FIG. 1, the rotor 20 comprises a two-pole ring magnet 21. However, the rotor 20 might comprise an alternative number of poles. Moreover, rather than a ring magnet 21, the rotor 20 may comprise a yoke to which permanent magnets are attached (surface permanent magnet) or embedded (interior permanent magnet).

The stator 30 comprises a stator core 31 and a plurality of coils 32 that define three phases, labelled A, B and C. In the particular example illustrated in the Figures, the stator core 31 is slotless and each phase (e.g. A) comprises two coils (e.g. A1 and A2) connected in series or in parallel. However, the stator core 31 might equally be slotted, and each phase A,B,C may comprise fewer or additional coils. The three phases A,B,C are connected in either a star or delta configuration. In the example shown in FIG. 2, the phases are connected in a star configuration. However, both configurations are possible and are considered below.

The control system 40 comprises a pair of terminals 41,42, an inverter 43, a current sensor 44, a gate driver module 45, and a controller 46.

The terminals 41,42 are connected or connectable to a power supply (not shown) supplying a DC voltage.

The inverter 43 is a three-phase inverter and comprises three legs, each leg comprising a pair of power switches Q1-Q6. The inverter 43 is connected to each of the three phases A,B,C of the stator 30. More particularly, each leg is connected to a terminal of a respective phase.

The current sensor 44 comprises a sense resistor R1 located between the inverter 43 and the zero-voltage terminal 42. The voltage across the current sensor 44 is output as signal I_PHASE, and provides a measure of the phase current during excitation. The use of a resistor provides a cost-effective means for sensing the phase current. However, other types of current sensor, such as a current transducer, may alternatively be used. Moreover, whilst in this particular example the control system 40 comprises a single current sensor, the control system 40 could conceivably comprise a plurality of current sensors. For example, the control system 40 may comprise a sense resistor on each leg (high-side or low-side) or line of the inverter 43 such that the phase current may be sensed during both excitation and freewheeling.

The gate driver module 45 drives the opening and closing of the switches Q1-Q6 of the inverter 43 in response to control signals output by the controller 46.

The controller 46 generates control signals for controlling the switches Q1-Q6 of the inverter 43. The control signals are output to the gate driver module 45, which in response drives the opening and closing of the switches Q1-Q6.

The control system 40 employs a position sensorless control scheme.

When the rotor 20 is stationary, the control system 40 may employ one of several known methods in order to start the rotor 20. For example, the control system 40 may excite the phases A,B,C in a predetermined sequence that ensures that, irrespective of the initial position of the rotor 20, the rotor 20 is driven forwards; this type of control is sometimes referred to as align and go. Alternatively, the control system 40 may determine the initial position of the rotor (e.g. by applying voltage pulses to the phases and measuring the resulting current), and then exciting the phases in a manner that drives the rotor 20 forwards. The particular method employed by the control system 40 in order to start the rotor 20 is not pertinent to the present invention.

With the rotor 20 rotating, the control system 40 employs six-step control in order to drive the rotor 20. In six-step control, sometimes referred to as six-step commutation or 120 degree commutation, each electrical cycle is divided into six sectors. The control system 40 then applies a different voltage vector to the phases within each sector. FIG. 3 illustrates the different sectors, along with the voltage vectors and the states of the switches for both star-connected and delta-connected phases. In addition to exciting the phases, the control system 40 may freewheel the phases. Freewheeling comprises opening one of the two switches that are closed during excitation. Phase current then circulates or freewheels around either a low-side loop or a high-side loop of the inverter. More particularly, the phase current flows down through the closed switch and up through the body diode of an open switch. In this particular example, the power switches are capable of conducting in both directions when closed. Accordingly, freewheeling may comprise closing the open switch such that the phase current flows through the switch rather than the less-efficient body diode during freewheeling.

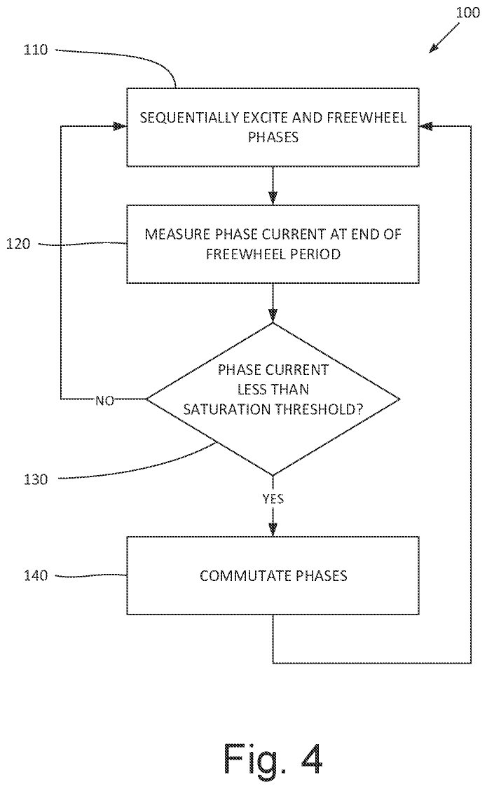

FIG. 4 illustrates a method 100 employed by the control system 40 when implementing six-step control.

The method 100 comprises sequentially exciting and freewheeling 110 the phases over each sector. The phases are excited with a different voltage vector over each sector. Upon exciting the phases, the magnitude of the phase current increases. When the phase current increases to an upper threshold, the phases are freewheeled for a fixed period of time, during which the magnitude of the phase current decreases. More particularly, the controller 46 generates control signals to excite the phases A,B,C with the appropriate voltage vector. The controller 46 then monitors the phase current via the I_PHASE signal. When the phase current increases to an upper threshold, the controller 46 generates control signals to freewheel the phases A,B,C.

The method 100 further comprises measuring 120 the magnitude of the phase current at the end of the freewheel period. The control system 40 comprises a single current sensor 44, which is capable of sensing the phase current during excitation only; it is not possible to sense the phase current during freewheeling. Accordingly, at the end of the freewheel period, the controller 46 again excites the phases A,B,C with the appropriate voltage vector in order to obtain a measure of the phase current via the I_PHASE signal.

The method 100 then comprises comparing the magnitude of the phase current (at the end of the freewheel period) against a saturation threshold, and determining 130 that a saturation event has occurred if the phase current is less than the saturation threshold. More particularly, the controller 46 compares the magnitude of the phase current against a saturation threshold, which is generated or stored by the controller 46.

In response to a saturation event, the method 100 comprises commutating 140 the phases. Otherwise, the method continues to sequentially excite and freewheel the phases in the manner described above. Commutation involves exciting the phases A,B,C with a different voltage vector. Commutation therefore defines the transition between two sectors. Upon commutating the phases, the method described above is repeated. However, the phases A,B,C are now excited with a different voltage vector.

The method 100 described above makes use of magnetic saturation in order to determine the position of the rotor 20 and thus the commutation point. As the rotor 20 rotates, the total magnetic flux linked by the stator 30 varies. As the rotor 20 approaches a commutation position (i.e. the position at which the phases are ideally commutated in order to maximise torque), the total magnetic flux linked by the stator 30 increases and the stator 30 begins to saturate. As the stator 30 begins to saturate, the inductance of the phases A,B,C decreases. As a result, the rates at which the phase current rises during excitation and falls during freewheeling increase. By freewheeling the phases for a fixed period of time, the magnitude of the phase current at the end of the freewheeling decreases as the rotor 20 approaches the commutation position.

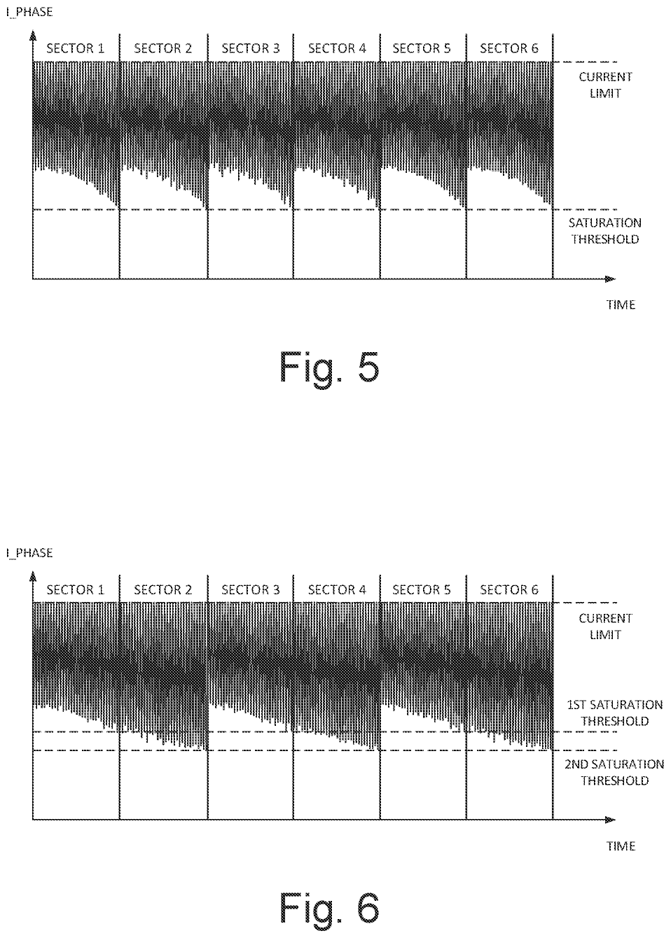

FIG. 5 illustrates the profile of the phase current over one electrical cycle when the phases of the motor 10 are star-connected. It can be seen that the profile of the phase current is substantially the same over each sector. This is because the profile of the phase inductance (i.e. how the inductance of the phases varies with rotor position) is substantially the same over each sector.

FIG. 6 illustrates the profile of the phase current over one electrical cycle when the phases of the motor 10 are delta-connected. It can be seen that the profile of the phase current is different for different sectors. This arises because, for delta-connected phases, the profile of the phase inductance is different for different sectors. Consequently, when the rotor 20 is at each commutation position, the phase current at the end of the freewheel period is different for different sectors. Accordingly, if the same saturation threshold were used for each sector, the commutation timing would be incorrect or less accurate for at least some of the sectors. This would then adversely affect the torque as well as the overall efficiency of the motor.

Where the profile of the phase inductance is different for different sectors, the control system 40 may employ different saturation thresholds for different sectors. In the particular example of FIG. 6, the profile of the phase current is substantially the same for each odd-numbered sector, and for each even-numbered sector. The control system 40 may therefore employ a first saturation threshold for odd-numbered sectors, and a second, different saturation threshold for even-numbered sectors.

The phase inductance over each even-number sector is lower than that over each odd-numbered sector. As a result, the magnitude of the phase current rises and falls at a faster rate in the even-numbered sectors. Consequently, when the rotor is at each commutation position, the magnitude of the phase current at the end of the freewheel period is lower for even-numbered sectors. The control system 40 therefore employs a second saturation threshold that is lower than the first saturation threshold.

By employing different saturation thresholds for different sectors, more accurate timing of commutation may be achieved, leading to increased torque, faster acceleration and improved efficiency.

In the methods described above, the control system 40 determines a saturation event for each and every sector and then commutates the phases in response to each saturation event. In an alternative method, the control system 40 may determine a saturation event for one sector and then use this saturation event to commutate the phases for multiple sectors. This alternative method may be then used with motors for which the profile of the phase inductance is different for different sectors, such as the example of FIG. 6.

As already noted, in the example of FIG. 6, the profile of the phase current is substantially the same over each even-numbered sector. Likewise, the profile of the phase current is substantially the same over each odd-numbered sector. The control system 40 may therefore determine saturation events during the even-numbered sectors or the odd-numbered sectors, but not both. So, for example, the control system 40 may determine saturation events during each even-numbered sector. In response to a saturation event, the control system 40 commutates the phases twice. More particularly, the control system 40 commutates the phase at times T and T+T_COM, where T_COM is the estimated commutation period for the next sector, i.e. the length of time required for the rotor to move from the current commutation position to the next commutation position.

In order to estimate the commutation period for the next sector, the control system 40 determines what the commutation period was for previous sectors. In particular, the control system 40 determines the interval, INT, between the present saturation event and the previous saturation event. Since saturation events are determined for every alternate sector (e.g. the even-numbered sectors), the interval between two saturation events corresponds to the sum of the previous two commutation periods. The control system then multiplies the interval, INT, by a scaling factor, S, in order to obtain the estimated commutation period, i.e. T_COM=INT*S.

When the speed of the rotor 20 is relatively constant, the time taken for the rotor 20 to move from one commutation position to the next does not change significantly from sector to sector. Accordingly, when the speed of the rotor is relatively constant, the control system 40 uses a scaling factor of 0.5. As a result, the estimated commutation period for the next sector is the average of the commutation periods for the previous two sectors.

On the other hand, when the speed of the rotor 20 is accelerating, the time taken for the rotor 20 to move from one commutation position to the next decreases. The commutation period for the next sector will therefore be shorter than the commutation periods of the previous sectors. Accordingly, when the speed of the rotor is accelerating, the control system 40 uses a scaling factor less than 0.5. Conversely, when the rotor is decelerating, the control system 40 uses a scaling factor greater than 0.5. The actual scaling factor used by the control system 40 will depend on the rate of the acceleration or deceleration of the rotor. In particular, a lower scaling factor is used for a faster rate of acceleration, and a higher scaling factor is used for a faster rate of deceleration.

The control system 40 may use a single fixed scaling factor during acceleration and/or deceleration. This then provides a relatively simple method for controlling the motor 10. Alternatively, the control system 40 may use a scaling factor that depends on the speed of rotor. Different scaling factors may be of use when the rate of acceleration and/or deceleration of the rotor is not constant. For example, the rate of acceleration of the rotor may be greater at lower speeds. Accordingly, the control system may use a first scaling factor (e.g. 0.4) over a first speed range and a second higher scaling factor (0.45) over a second higher speed range.

With this alternative method, saturation events may be determined using a single saturation threshold. Differences in the phase inductance for different sectors are then addressed by commutating the phases multiple times in response to each saturation event. In doing so, more accurate timing of commutation may be achieved, in spite of the differences in phase inductance, leading to increased torque, faster acceleration and improved efficiency.

As the rotor 20 rotates, a back EMF is induced in the phases A,B,C. The back EMF acts in opposition to the applied voltage used to excite the phases. Consequently, the rate at which phase current rises during excitation and falls during freewheeling depends not only on the inductance of the phases A,B,C but also on the magnitude of the back EMF. As the speed of the rotor 20 changes, so too does the magnitude of the back EMF. Consequently, if the same saturation threshold were used at different motor speeds, commutation would occur at slightly different rotor positions. This may then adversely affect the torque and efficiency of the motor 10. Accordingly, the control system 40 may vary the saturation threshold(s) in response to a change in a speed of the rotor 20.

As the speed of the rotor 20 increases, so too does the magnitude of the back EMF. As a result, the rate at which the magnitude of the phase current rises during excitation decreases, and the rate at which the magnitude of the phase current falls during freewheeling increases. Accordingly, the magnitude of the phase current at the end of freewheeling decreases. The control system 40 may therefore decrease the saturation threshold(s) in response to an increase in the speed of the rotor 20.

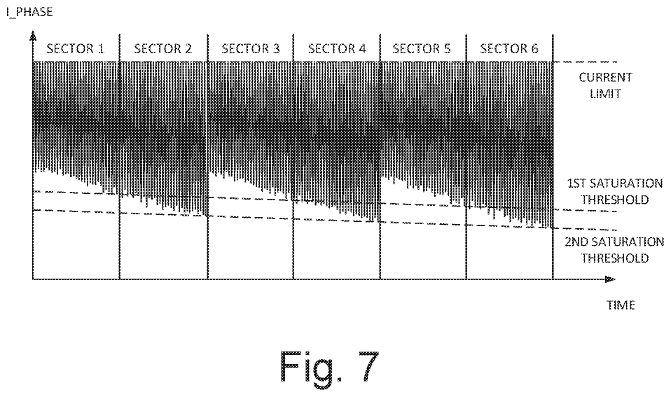

FIG. 6 illustrates the profile of the phase current when the motor is operating at constant speed. By contrast, FIG. 7 illustrates the profile of the phase current when the motor is accelerating.

There are several ways in which the control system 40 may vary the saturation threshold(s) with speed. In one example, the controller 46 may comprise a lookup table of different saturation thresholds for different speeds. The controller 46 then selects a saturation threshold(s) from the lookup table according to the speed of the rotor 20, as determined from the commutation period (i.e. the interval between two successive commutations). In another example, the saturation threshold(s) may be defined by an equation (i.e. function of speed), which the controller 46 then solves in response to a saturation event, i.e. in response to a saturation event, the controller 46 calculates a new saturation threshold(s) to be used when determining the next saturation event. In a still further example, the controller 46 may decrease the saturation threshold(s) by a fixed amount with each saturation event.

The temperature of the rotor 20, and to a lesser extent the temperature of the stator 30, may influence the total flux that is linked to the stator 30. As a result, the phase inductance may be sensitive to changes in the temperature of the motor 10. The control system 40 may therefore employ a saturation threshold that depends on the temperature of the motor 10. For example, the control system 40 may comprise a temperature sensor, such as thermistor, and the controller 46 may select a saturation threshold that depends on the output of the temperature sensor.

With the methods described above, the control system 40 assesses the rotor position with each current chop (i.e. with each freewheel). Consequently, the frequency of current chopping defines the resolution with which the position of the rotor may be determined. At relatively low rotor speeds, the length of each sector is relatively long and the magnitude of the back EMF is relatively small. As a result, the phase current is chopped many times over each sector and thus the commutation position of the rotor may be determined with relatively good accuracy. As the speed of the rotor increases, the length of each sector decreases and the magnitude of the back EMF increases. The phase current is therefore chopped less frequently and thus the margin of error in the commutation position increases. The methods described above may therefore be employed by the control system 40 during acceleration only, and the control system 40 may switch to a different sensorless scheme in order to control the motor 10 under steady state conditions. Alternatively, the control system 40 may use the methods described above for both acceleration and steady state operation. The only requirement is that, when operating at a steady state, the phase current is chopped at a sufficiently high frequency that the position of the rotor can be determined with sufficient accuracy. In this regard, the control system 40 may use different freewheel periods over different speed ranges so as to ensure that the phase current continues to be chopped at a sufficiently high frequency. In particular, the control system 40 may use shorter freewheel period at a higher rotor speed. The freewheel period would continue to be fixed over each sector.

In the examples described above, the control system 40 comprises a single current sensor 44 in the form of a sense resistor R1, which has the benefit of reducing the component cost of the control system 40. As noted above, the control system 40 may comprise additional or alternative current sensors such that the phase current may be sensed during both excitation and freewheeling. For example, the control system may comprise a sense resistor on each leg (high-side or low-side according to the loop around which freewheeling occurs) or line of the inverter. In this instance, the controller 46 may measure and compare the phase current against the saturation threshold throughout the freewheel period. A saturation event may then be determined without having to wait until the end of the freewheel period. As a result, the accuracy of commutation may be improved, particularly at higher speeds.

In the methods described above, the control system 40 freewheels the phases for a fixed period of time. A saturation event is then determined to have occurred if the phase current, during or at the end of the freewheel period, is less than a saturation threshold. In an alternative method, the control system 40 may freewheel the phases until the magnitude of the phase current decreases to a lower threshold. The phase current is therefore chopped between the upper threshold and the lower threshold. The control system 40 then determines a saturation event by measuring either the interval between the start and end of freewheeling (i.e. the time taken for the phase current to decrease from the upper threshold to the lower threshold) or the interval between the start and end of excitation (i.e. the time taken for the phase current to increase from the lower threshold to the upper threshold). As noted above, as the rotor 20 approaches the commutation position, the phase inductance decreases. As a result, the rates at which the phase current rises during excitation and falls during freewheeling increase. Accordingly, a saturation event may be determined by measuring an interval that corresponds to either the current rise time or the current fall time, and then comparing the measured interval against a threshold. A potential drawback with this approach, however, is that the current rise and fall times may be relatively short and therefore a controller having a relatively high-resolution timer may be required in order to discriminate differences in the measured interval.

In a more general sense, the control system 40 may be said to freewheel the phases for either a fixed period of time or until the magnitude of the phase current decreases to a lower threshold. The control system 40 then measures a parameter corresponding to either (i) the magnitude of the phase current during or at the end of the freewheel period when freewheeling for the fixed period of time, or (ii) the interval between the start and end of freewheeling or the start and end of excitation when freewheeling until the phase current decreases to the lower threshold. The control system then determines that a saturation event has occurred when the measured parameter is less than the saturation threshold.

As noted above, the control system 40 may vary the saturation threshold in response to changes in the speed of the rotor 20. As the speed of the rotor 20 increases, so too does the magnitude of the back EMF. As a result, the rate at which phase current rises during excitation decreases, and the rate at which the phase current falls during freewheeling increases. Accordingly, when the measured parameter is the magnitude of the phase current or the time interval between the start and end of freewheeling, the control system 40 decreases the saturation threshold in response to an increase in the rotor speed. Conversely, when the measured parameter is the interval between the start and end of excitation, the control system 40 increases the saturation threshold in response to an increase in the rotor speed.

With the methods described above, changes in the phase inductance rather than the back EMF are used to determine the rotor position. The methods may therefore be used to drive the rotor at relatively low speeds. The profile of the phase inductance may differ for different sectors. Nevertheless, with the methods described above, accurate commutation may continue to be achieved. In particular, different saturation thresholds may be used for different sectors, or the phases may be commutated multiple times in response to a single saturation event.

1. A method of controlling a three-phase permanent-magnet motor, the method comprising:
sequentially exciting and freewheeling phases of the motor over a plurality of sectors, wherein the phases are excited with a different voltage vector for each sector, the phases are freewheeled when a magnitude of phase current increases to an upper threshold, and the phase are freewheeled for a fixed period of time or until the magnitude of the phase current decreases to a lower threshold;
measuring a parameter corresponding to the magnitude of the phase current during or at the end of freewheeling when the phases are freewheeled for the fixed period of time, or an interval between a start and end of freewheeling or a start and end of excitation when the phases are freewheeled until the magnitude of the phase current decreases to the lower threshold;
determining that a saturation event has occurred when the measured parameter is less than a saturation threshold; and
commutating the phases in response to the saturation event,
wherein the method comprises (i) using a first saturation threshold when determining a saturation event within a first sector, and using a second different saturation threshold when determining a saturation event within a second sector, or (ii) commutating the phases multiple times in response to the saturation event.

2. The method as claimed in claim 1, wherein the saturation threshold used when determining a saturation event within each even-numbered sector is less than the saturation threshold used when determining a saturation event within each odd-numbered sector.

3. The method as claimed in claim 1, wherein the first saturation threshold is used when determining a saturation event within each odd-numbered sector, and the second saturation threshold is used when determining a saturation event within each even-numbered sector.

4. The method as claimed in claim 1, wherein the method comprises determining an interval between the saturation event and a previous saturation event, and commutating the phases in response to the saturation event at times T and T+INT*S, where INT is the interval and S is a scaling factor.

5. The method as claimed in claim 4, wherein the method comprises determining a rate of change in a speed of the motor, employing a scaling factor less than 0.5 when the speed of the motor is accelerating, and employing a scaling factor greater than 0.5 when the speed of the motor is decelerating.

6. The method as claimed in claim 4, wherein the scaling factor is less than 0.5.

7. The method as claimed in claim 5, wherein the scaling factor is fixed over a range of motor speeds spanning at least 10 krpm.

8. The method as claimed in claim 1, wherein the method comprises varying the saturation threshold in response to a change in a speed of the motor.

9. The method as claimed in claim 8, wherein the measured parameter is the magnitude of the phase current or the time interval between the start and end of freewheeling and the method comprises decreasing the saturation threshold in response to an increase in the speed of the motor, or the measured parameter is the interval between the start and end of excitation and the method comprises increasing the saturation threshold in response to an increase in the speed of the motor.

10. A three-phase permanent-magnet motor comprising a control system configured to perform the method as claimed in claim 1.

11. The motor as claimed in claim 10, wherein the control system comprises an inverter, at least one current sensor, a gate driver module, and a controller; the inverter is coupled to each of the phases; the current sensor outputs a signal indicative of the magnitude of the phase current; the gate driver module drives the opening and closing of switches of the inverter in response to control signals from the controller; and the controller (i) generates control signals to excite the phases, (ii) monitors the signal of the current sensor, (iii) generates control signals to freewheel the phases when the magnitude of the phase current increases to the upper threshold, (iv) measures the parameter, and determines that a saturation event has occurred when the measured parameter is less than a saturation threshold.

12. The motor as claimed in claim 10, wherein the phases are delta-connected.
